(19) United States
(12) Patent Application Publication
(10) Pub. No.: US 2024/0156089 A1
(43) Pub. Date: May 16, 2024

(54) METHOD FOR PRODUCING AN ATTRACTANT COMPOSITION

(71) Applicant: Biogents AG, Regensburg (DE)

(72) Inventor: Martin GEIER, Sulzbach-Rosenberg (DE)

(21) Appl. No.: 18/282,076

(22) PCT Filed: Mar. 16, 2022
(86) PCT No.: PCT/EP2022/056821

§ 371 Date: Sep. 14, 2023

(30) Foreign Application Priority Data
Mar. 19, 2021 (DE) 10 2021 106 811.8

(51) Int. Cl. A01N 37/02; A01N 25/08; A01P 19/00

(52) U.S. Cl. CPC A01N 37/02; A01N 25/08; A01P 19/00

(57) ABSTRACT

The invention relates to a method (100) used to produce an attractant composition (120) and to an attractant composition (120) to attract bloodsucking arthropods (31) and/or fruit flies. In this context, a porous substrate is loaded with a buffer system, in which context the buffer system is at least largely completely absorbed by the porous substrate. Subsequently, at least one attractant is introduced into the substrate loaded with the buffer system.

### CLAIM OF PRIORITY

The present application claims priority to International Application PCT/EP2022/056821, filed Mar. 16, 2022, which in turn claims priority to German Application DE 10 2021 106 811.8, filed Mar. 19, 2021, which are incorporated by reference.

### FIELD OF THE INVENTION

The present invention relates to a method used to produce an attractant composition and to an attractant composition according to the features of the independent claims.

### BACKGROUND OF THE INVENTION

The present invention relates to an attractant composition that is suitable, in particular, to attract bloodsucking arthropods and/or fruit flies.

Bloodsucking insects frequently go by olfactory and/or optical stimuli in order to track humans or animals. It is a problem, in particular, that bloodsucking insects frequently transmit diseases, which is why attempts are made to keep these insects away from human dwellings and/or gatherings. In this context it is possible to rely on deterrence, for example, by using chemical insect repellents. Alternatively, there are various insect traps that are used to catch bloodsucking arthropods. Such insect traps frequently operate based on olfactory and/or optical attractants.

It is known, for example, that carbon dioxide and lactic acid attract a number of bloodsucking insect species. The US patent document published as U.S. Pat. No. 4,907,366 A, for example, describes the use of a composition of lactic acid, carbon dioxide, and water in combination with heat to attract mosquitoes.

It is the object of the invention to provide an attractant composition that is easy to handle and, in particular, does not require the use of a plurality of receptacles or vials in order to provide a plurality of attractant components.

### SUMMARY OF THE INVENTION

The object is solved by a method with the features of the independent claims used to produce an attractant composition to attract bloodsucking arthropods and/or fruit flies and by an attractant composition with the features of the independent claims. Further advantageous embodiments of the invention are described in the subclaims.

Furthermore described and claimed is a method that is used to attract bloodsucking arthropods and/or fruit flies with an attractant composition according to the invention.

The attractant composition is used to attract bloodsucking arthropods and fruit flies. Arthropods, which include mosquitoes, black flies, sand flies, tsetse flies, blow flies, and also house flies, fleas, lice, etc., among them many disease carriers, are therefore highly relevant from a medical and veterinary point of view. Mosquitoes include, for example, the genus Anopheles, many species of which are responsible for the transmission of malaria. All species of the Drosophila genus are included.

The attractant composition consists of a porous substrate in which at least effective quantities of at least one attractant are embedded, adsorbed, and/or bound. Preferably, small amounts of water can moreover be present in the porous substrate. According to the method described here that is used to attract bloodsucking arthropods and/or fruit flies, the at least one attractant is slowly released from the attractant composition, in particular by evaporation. Thereby, the at least one attractant enters the surrounding area and can thus effectively attract bloodsucking arthropods and/or fruit flies.

Synthetic, porous solid bodies in the form of a granular bulk material, for example, can be used for the porous substrate. Known substrate bodies can be in the form of organic substances (for example, polymer foams, synthetic fiber knits, ion exchange resins) or of an inorganic substance (for example, sand, aluminum oxide activated carbon). The synthetic, porous solid bodies used as substrates are preferably chemically inert and stable over a longer period of time. This includes sufficient chemical and mechanical resistance. Due to its porosity, the substrate has a large usable surface area for the below-described adsorption of the buffer system and the attractant. Preferably, the buffer system and the at least one attractant are embedded in the pores of the substrate.

The method used to produce the attractant composition to attract bloodsucking arthropods and/or fruit flies provides that the porous substrate is mixed with a buffer system, with the buffer system being at least largely completely taken up, in particular absorbed, by the porous substrate.

A porous substrate is filled into a drum mixer, for example. The buffer system is subsequently added and mixed with the porous substrate until the substrate is completely soaked with the buffer system. Excess buffer system can preferably be removed before further processing. In this context, the buffer system is, in particular, embedded in the pores of the substrate and/or adsorbed to the outer surfaces of the substrate.

In a subsequent method step, at least one attractant is added to the substrate loaded with the buffer system and is mixed with it. In this context, the at least one attractant is absorbed and/or bound within the buffer-filled pores of the substrate and/or on the outer surfaces of the carrier material.

The attractant composition produced in such a manner has the advantage that the at least on attractant contained therein is released slowly over time from the attractant composition and is emitted to the surrounding area or the environment by evaporation, whereby the attractant composition unfolds its effect on the bloodsucking arthropods and/or fruit flies over a longer period of time. It is provided, in particular, that the buffer system supports the absorption of the attractant into the substrate and/or the release of the attractant from the substrate. Particularly preferably, the buffer system supports the slow release of the attractant to the surrounding area.

In particular, the volatility of acidic components of the attractant composition, for example, of lactic acid and/or of hexanoic acid, is dependent on the pH. At high pH values, the components are completely present as salts and are not volatile. At low pH values, by contrast, these components are highly volatile. The release of the attractant can be specifically influenced and adjusted by selecting a suitable pH.

Small quantities of water may be necessary in order for the attractant to be released. This water is preferably provided by the buffer system. In this case, the release of the attractant takes place in a manner comparable to steam distillation.

According to one embodiment of the invention, the buffer system consists of or comprises at least one aqueous ammonium salt of a carboxylic acid or at least one aqueous ammonium salt of a fatty acid or at least one aqueous ammonium salt of acetic acid, lactic acid, propionic acid, butyric acid, valeric acid, caproic acid, enanthic acid, or caprylic acid. One embodiment of the invention can provide to use no racemic carboxylic acids, but rather in each case a pure (D)-carboxylic acid or a pure (L)-carboxylic acid, for example pure (D)-lactic acid or a pure (L)-lactic acid. The buffer system preferably has a substantially neutral pH.

The at least one attractant is preferably selected from a group of at least one C1 to C10 carboxylic acid and/or a corresponding salt of that group, in particular, from a group comprising formic acid, acetic acid, lactic acid, propionic acid, and caproic acid. The at least one attractant can furthermore be selected from a group comprising dichloromethane, trichloromethane, acetone, phenol, 1-Octen-3-ol, glycolic acid, thiolactic acid, thiolmalic acid, tartaric acid, and/or mandelic acid, fermenting yeast and/or an extract of fermenting yeast. A particularly preferred compound for a further attractant in this context is acetic acid.

The attractant composition produced in such a manner is present in an easily portionable form and can now be directly used in a suitable insect trap. An appropriate quantity of attractant composition is, for example, introduced directly into the insect trap, which can preferably provide an appropriate receiving device for the attractant composition.

A preferred embodiment moreover provides that the attractant composition is portioned and arranged in a packaging consisting of a gas-permeable container. The attractant composition can be arranged, for example, in a packaging consisting of packaging bags of a gas-permeable material, for example, of a porous polyethylene or of a nonwoven fabric or of another suitable material.

The attractant composition arranged in a gas-permeable packaging material can be directly placed along with the packaging into an appropriate insect trap and used immediately. Handling is thereby significantly simplified, since the attractant composition is not a loose bulk material, but due to the packaging rather present in an easily manageable, in particular pre-portioned, form, in particular, in which there is no direct contact of the user with the attractant composition.

An alternative embodiment can provide that the packaging which the attractant composition is arranged in is a container or packaging bag consisting of a fluid-impermeable material. In this context, it can be likewise provided that the attractant composition is pre-portioned and accordingly packaged in handy portions. In this case, the packaging material has to be removed before use of the attractant composition, since the packaging material prevents the release of the at least one attractant.

One embodiment of the invention can provide that the attractant composition is additionally loaded with at least one scent. In this context, the scent can be directly introduced into or applied onto the substrate loaded with buffer system and attractant. Alternatively, the substrate loaded with buffer system can be loaded with the scent first and, subsequently thereto, the loading with the at least one attractant can be carried out. The scent can be a scent that improves the handling of the attractant composition for the user, but has no influence on the behavior of the bloodsucking arthropods and/or fruit flies. Particularly preferable is the use of additional scents that both improve handling for the user and have a positive attraction effect on the bloodsucking arthropods and/or fruit flies.

According to a further embodiment, the attractant composition, that is to say, the substrate loaded with the buffer system and at least one attractant, can be loaded with at least one further attractant for bloodsucking arthropods and/or fruit flies.

The at least one further attractant is preferably selected from a group of at least one C1 to C10 carboxylic acid and/or a corresponding salt of that group, in particular, formic acid, acetic acid, lactic acid, propionic acid, and caproic acid. The at least one further attractant can furthermore be selected from a group comprising dichloromethane, trichloromethane, acetone, phenol, 1-Octen-3-ol, glycolic acid, thiolactic acid, thiolmalic acid, tartaric acid, and/or mandelic acid, fermenting yeast and/or an extract of fermenting yeast. A particularly preferred compound for a further attractant in this context is acetic acid.

According to one embodiment, it is provided that in addition to the at least one attractant of the attractant composition, components of the buffer system can also transition to the gas phase of the attractant composition and support or intensify the attraction effect of the at least one attractant component. In addition to the release of the attractant, there can be, in particular, a release of ammonia and the corresponding carboxylic acid of the buffer system. These substances are likewise emitted in gaseous form from the attractant composition by slow decomposition and by evaporation, and they transition to the gas phase together with the at least one attractant.

According to one embodiment of the invention, it is provided for the substrate to be formed by an inert matrix. The matrix preferably has a pore size between 2 μm and 100 μm, in particular, a pore size between 5 μm and 30 μm. The inert matrix is furthermore designed to absorb liquids.

The substrate preferably has microporous structures that act like small sponges and can absorb other substances, in particular liquids, in which case they can preferably absorb a multiple of their own weight.

The substrate can be formed from a polymeric synthetic material, for example, such as PP (polypropylene), LDPE (low-density polyethylene), HDPE (high-density polyethylene), EVA (ethylene-vinyl acetate), PA6 (polyamide 6), PET (polyethylene terephthalate), PC (polycarbonate), PS (polystyrene), PMMA (polymethyl methacrylate), or the like. Preferably, a substrate is used that has an open cell structure with at least partially interconnected spaces.

When the appropriate liquids or meltable solids are mixed with the substrate, the micro-spaces in the polymeric material fill by capillary absorption. When fully loaded, the system remains dry and free flowing.

It should be pointed out that the attractant composition of the present invention is not limited in terms of quality and quantity to the above-mentioned components and their effects. The composition can contain further ingredients, for example, scents, preservatives, stabilizers, further attractants, etc. The effects of the disclosed attractant composition can furthermore be intensified by combination with other attractants, in particular, with other attractants provided by the appropriate insect trap. These include, for example, optical stimuli, thermal radiation, moisture, and airflows.

The attractant composition described here can be used in a commercially available or in a self-made insect trap in any form in order to attract arthropods and/or fruit flies and thus gather them in the insect trap. The at least one attractant, and, if applicable, ammonia and the carboxylic acid correspondingly used in the buffer system, and, if applicable, further scents and/or attractants, are released from the attractant composition and can diffuse out of or away from the insect trap with or without a gas flow as a carrier (for example, air, carbon dioxide, etc.). Traps known from the prior art, such as those commercially available from various suppliers, can be used as effective traps.

Embedding the attractant in a porous substrate loaded with a suitable buffer system results in a controlled, time-delayed release of the attractant from the attractant composition, which allows a long-term use in order to effectively attract and collect arthropods (for example, mosquitoes) over a specific, sufficient period of time with an insect trap.

Materials that actively attack arthropods can moreover be arranged adjacent to the attractant composition in such a manner that there can be preferably no interaction or reaction between the chemicals of the attractant composition and the materials attacking the arthropods. Combining the attractant composition with insecticides, for example, advantageously results in the possibility to locally limit the use of the insecticides so that it is not necessary to distribute the insecticide widely.

It should be explicitly mentioned at this point that all aspects and embodiment variants explained in the context of the apparatus according to the invention can likewise pertain to or constitute partial aspects of the method according to the invention. If specific aspects and/or interrelations and/or effects relating to the apparatus according to the invention are referred to at some point in the present description or in the claims definitions, this therefore likewise pertains to the method according to the invention. The same applies conversely, so that all aspects and embodiment variants explained in the context of the method according to the invention can likewise pertain to or constitute partial aspects of the apparatus according to the invention. If specific aspects and/or interrelations and/or effects relating to the method according to the invention are referred to at some point in the present description or in the claims definitions, this therefore likewise pertains to the apparatus according to the invention.

### BRIEF DESCRIPTION OF THE FIGURES

In the following passages, the attached figures further illustrate typical embodiments of the invention and their advantages. The size ratios of the individual elements in the figures do not necessarily reflect the real size ratios. It is to be understood that in some instances various aspects of the invention may be shown exaggerated or enlarged in relation to other elements in order to facilitate an understanding of the invention.

FIG. 1 schematically illustrates the method steps of a first embodiment of a method used to produce an attractant composition.

FIG. 2 schematically illustrates the method steps of a second embodiment of a method used to produce an attractant composition.

FIG. 3 illustrates the use of an attractant composition in a first embodiment of an insect trap.

FIG. 4 illustrates the use of an attractant composition in a second embodiment of an insect trap.

The same or equivalent elements of the invention are designated using identical reference characters. Furthermore, and for the sake of clarity, only the reference characters relevant for describing the individual figures are provided. It should be understood that the detailed description and specific examples of the embodiments of the attractant composition or of the method according to the invention are intended for purposes of illustration only and are not intended to limit the scope of the invention.

### DETAILED DESCRIPTION OF THE INVENTION

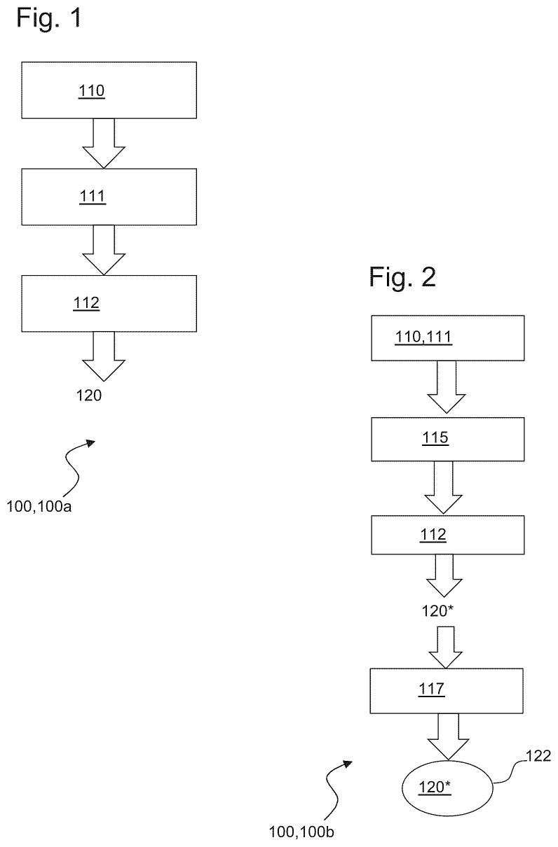

FIG. 1 schematically illustrates the method steps of a first embodiment of a method 100, 100a used to produce an attractant composition 120, and FIG. 2 schematically illustrates the method steps of a second embodiment of a method 100, 100b used to produce an attractant composition 120.

Both methods 100, 100a, 100b provide that in a first method step 110, a porous substrate is loaded with a buffer system, wherein the buffer system is at least largely completely absorbed by the porous substrate. In particular, the porous substrate is mixed in a drum mixer with a buffer system consisting of or comprising an aqueous ammonium salt of a carboxylic acid.

An excess of the buffer system is used, for example. In a second method step 111, the excess buffer system is removed so that a substrate saturated with buffer system is now present.

In a third method step 112, at least one attractant is then added and mixed with the substrate loaded or saturated with buffer system. In this context, the attractant becomes embedded in the buffer-filled pores of the substrate system and/or is adsorbed to the outer surfaces of the substrate.

The at least one attractant is preferably selected from a group of at least one C1 to C10 carboxylic acid and/or a corresponding salt of that group, in particular, from a group comprising formic acid, acetic acid, lactic acid, propionic acid, and caproic acid. The at least one attractant can furthermore be selected from a group comprising dichloromethane, trichloromethane, acetone, phenol, 1-Octen-3-ol, glycolic acid, thiolactic acid, thiolmalic acid, tartaric acid, and/or mandelic acid, fermenting yeast and/or an extract of fermenting yeast. A particularly preferred compound for a further attractant in this context is acetic acid.

The substrate loaded in such a manner with buffer system and at least one attractant forms the attractant composition 120.

The method 100b according to the second embodiment illustrated in FIG. 2 additionally provides that after loading the porous substrate with the buffer system and, if required, removing excess buffer system in an intermediate method step 115, at least one scent is added to the substrate loaded with buffer system before an appropriate quantity of attractant is subsequently added in analogy to FIG. 1 in a third method step 112, and, by mixing the attractant with the substrate loaded with buffer system and scent, it is again homogeneously distributed on the surface and/or within the pores of the substrate, whereby an attractant composition 120* that is additionally loaded with scent is formed. Alternatively, an attractant composition 120 produced according to the method 100a of FIG. 1 can also be loaded with scent in the step following the third method step 112.

The scent can be a scent that improves the handling of the attractant composition 120, 120* for the user, but has no other influence, in particular no negative influence, on the behavior of the bloodsucking arthropods and/or fruit flies. Particularly preferable is the use of additional scents that both improve handling for the user and have a positive attraction effect on the bloodsucking arthropods and/or fruit flies.

The attractant composition 120, 120* produced in such a manner has the advantage that the attractant is slowly released over time. This is achieved, in particular, by the buffer system that is used, as the volatility of acidic components, for example, of lactic acid and/or of hexanoic acid, is dependent on the pH. At high pH values, the components are completely present as salts and are not volatile. At low pH values, by contrast, these components are highly volatile. The release of the attractant composition 120, 120* can be specifically influenced and adjusted by selecting a suitable pH for the buffer system.

It can be additionally provided that the ammonium salt of the carboxylic acid of the buffer system likewise slowly decomposes over time, whereby ammonia and the corresponding acids are released and emitted to the surrounding area or environment by evaporation. In this context, the attractant, in particular, but also the ammonia and the carboxylic acid released from the buffer system, transition to the gas phase of the attractant composition 120 and in the process unfold an attraction effect on the bloodsucking arthropods and/or fruit flies.

Embedding the attractant in the porous substrate and/or binding the attractant to the porous substrate, results, in particular, in a controlled, time-delayed release of at least the attractant from the attractant composition 120, 120*, which allows a long-term use in order to effectively attract bloodsucking arthropods and/or fruit flies over a specific, sufficient period of time, for example to collect and/or kill them with an insect trap.

The attractant composition 120, 120* is present in an easily portionable form and can now be directly used in an appropriate insect trap. Moreover illustrated in FIG. 2 is the attractant composition 120* being portioned in a fourth method step 117 and being arranged and packaged in a packaging 122. The packaging 122 can be formed, for example, by a gas-permeable container or packaging bag, which consists, for example, of a porous polyethylene or of a nonwoven fabric or of another suitable material. In this case, the attractant composition 120, 120* packaged in such a manner can be used directly in an insect trap together with the packaging 122 because the gas-permeable packaging 122 allows the release of the attractant and, if applicable, of ammonia and carboxylic acid of the buffer system into a gas phase outside the packaging 122.

Another non-illustrated embodiment of the invention can provide that the attractant composition 120, 120* is loaded with at least one further attractant in a further method step. In this context, the further attractant can be applied before or after the substrate loaded with the buffer system has been loaded with at least one first attractant.

The at least one further attractant is preferably selected from a group of at least one C1 to C10 carboxylic acid and/or a corresponding salt of that group, in particular, formic acid, acetic acid, lactic acid, propionic acid, and caproic acid. The at least one further attractant can furthermore be selected from a group comprising dichloromethane, trichloromethane, acetone, phenol, 1-Octen-3-ol, glycolic acid, thiolactic acid, thiolmalic acid, tartaric acid, and/or mandelic acid, fermenting yeast and/or an extract of fermenting yeast. A particularly preferred compound for a further attractant in this context is acetic acid.

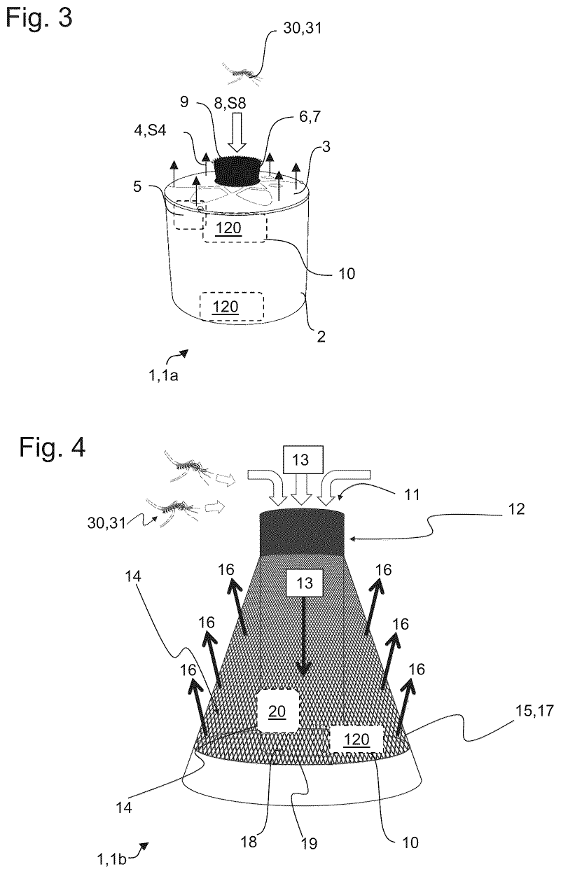

The attractant composition 120 described here can be used in a commercially available or in a self-made insect trap in any form in order to attract arthropods and/or fruit flies and thus gather them in the insect trap. FIG. 3 illustrates the use of an attractant composition 120 in a first embodiment of an insect trap 1, 1a, and FIG. 4 illustrates the use of an attractant composition in a second embodiment of an insect trap 1, 1b.

The insect trap 1, 1a according to FIG. 3 comprises an approximately hollow cylindrical collection container 2 for receiving the attracted and captured insects 30, for example, mosquitoes 31. Arranged as a top cover on the collection container 2 is a flat or slightly curved, light-colored outflow surface 3. A weak, even, upwardly directed airflow 4 emanates therefrom. This extensive, weak, even airflow 4 is attractive for many insects 30, in particular for mosquitoes 31 or the like. The airflow 4 at a flow velocity S4 is generated, for example, by at least one air blower 5 arranged below the outflow surface 3. Furthermore, the effect of the airflow 4 can be intensified by warmth and/or by addition of further attractants, in particular of chemical attractants.

The outflow surface 3 can additionally be provided with a glue and/or an insecticide such that insects 30 landing on the outflow surface 3 are immediately trapped and/or killed.

Moreover provided is an intake duct 6. In the illustrated exemplary embodiment, this intake duct 6 is designed, in particular, as a dark contrast spot 7 on the outflow surface 3. Via the intake duct 6, ambient air 8, for example, at a flow velocity S8 is sucked in. In this case, the flow velocity S8 of the ambient air 8 intake is considerably higher than the flow velocity S4 of the airflow 4 outflowing via the outflow surface 3. In particular, it can be provided that only one single air blower 5 is used for the intake of the ambient air 8 and for generating the outflowing airflow 4.

For the purpose of better illustrating the three-dimensionality and, in particular, the form of the intake duct 6, the upper edge of the intake opening 9 is indicated by a dashed line. The illustration, however, gives no indication of the color design of the edge. Preferably, this edge is also dark and, in particular, forms no contrast with the remaining intake duct 6.

The attractant composition 120 is arranged inside the collection container 2 such that the attractant having transitioned to the gas phase flows outside together with the airflow 4 via the outflow surface 3. A receiving device 10 for the attractant composition 120 can be formed, for example, within the collection container 2. When using an attractant composition 120 packaged in gas-permeable packaging bags, a hook or a suitable hanging device, for example, can be provided inside the collection container 2 for attaching the packaging bag thereto. For optimal effect of the attractant composition 120, it is preferably provided to arrange the attractant composition 120 adjacent to the air blower 5 and within the weak, outflowing airflow 4.

The at least one attractant contained in the attractant composition 120, and, if applicable, further scents and/or attractants and/or ammonia and carboxylic acid from the buffer system, are released from the attractant composition 120 and can diffuse out of or upward away from the insect trap 1a with the weak airflow 4 as a carrier.

The insect trap 1, 1b according to FIG. 4 illustrates the essential principles of a possible embodiment variant of an insect trap 1b that can serve, in particular, to attract and/or capture insects 30, in particular, flying insects and/or insect pests, such as mosquitoes, yellow fever mosquitoes, Zika mosquitoes, tiger mosquitoes, etc.

The insect trap 1b has a top, circular intake opening 11, which continues in a cylindrical intake duct 12 leading vertically downward, in which there is an airflow applying negative pressure or a suction flow 13 to the intake opening 11 and leading to an interior space 14 of the insect trap 1b or into it. The insect trap 1b is moreover provided with a frustoconical outer wall 15 having a surface that is at least partially permeable to outflowing air 16, the surface being formed, in particular, by a net-like structure 17 with a mesh size large enough for a sufficient outflowing airflow 16 to pass through, however, with a mesh size that reliably prevents insects 30 captured in the interior space 14 of the trap 1b from escaping.

The outer wall 15 encloses the intake duct 12 in the vicinity of the intake opening 11 and envelops the intake duct 12 in the downward continuing further region at a changing radial distance such that the outer wall 15 widens conically downward. The insect trap 1b is moreover provided with a bottom side 18 opposite the intake opening 11, which bottom side 18 connects to the outer wall 15 and is largely impermeable to inflowing or outflowing air, and which bottom side 18 is spaced apart from an open, lower front side 19 of the intake duct 12 extending into the interior space 14 of the insect trap 1b. In the illustrated exemplary embodiment of the insect trap 1b, the bottom side 18 is evenly and cylindrically shaped such that is aligned perpendicular to the longitudinal axis of the intake duct 12.

At least one fan 20 generating the suction flow 13 can be arranged inside the intake duct 12. The suction flow 13 has an air velocity that, if possible, makes it significantly more difficult for the attracted insects 30 to escape in the vicinity of the intake opening 11. The insects 30 are rather to be sucked into the interior space 14 of the trap 1b by the sufficiently strong suction flow 13 and to be reliably prevented there from flying back out of the interior space 14. Suitable means for retaining or killing the captured insects 30 can be arranged inside the trap 1b, which means are however not illustrated here.

The insect trap 1b can be mountable in a hanging or standing position, such that the intake opening 11 is directed upward and the intake duct 12 preferably extends in an approximately vertical direction, with the bottom side 18 forming a horizontal bottom closure of the trap 1b.

The outflowing air 16 already presents an attracting stimulus for the insects. As an additional attracting stimulus, an attractant composition 120, again produced according to the method 100 of FIG. 1 or FIG. 2, is arranged inside the insect trap 1b, in particular, inside the interior space 14, such that the attractant having transitioned to the gas phase and, if applicable, the ammonia and the carboxylic acid of the buffer system, can flow outside together with the outflowing air 16 via the frustoconical outer wall 15 of the insect trap 1b and can unfold its attraction effect. In this embodiment of an insect trap 1b, it is also possible, for example, that a receiving device 10 for the attractant composition 120 is formed in the interior space 14 in analogy to the receiving device 10 described in the context of FIG. 3.

The embodiments, examples and alternatives of the preceding paragraphs, the claims, or the following figures and description, including any of their various views or their particular individual features, may be taken independently or in any combination. Features described in connection with one embodiment are applicable to all embodiments, unless such features are incompatible.

If illustrations and aspects are generally referred to as being “schematic” in the context of the figures, this is by no means intended to imply that the illustrations of the figures and their description are of inferior significance with regard to the disclosure of the invention. The person skilled in the art is fully capable of gathering sufficient information from the schematically and abstractly drawn illustrations for facilitating the understanding of the invention without the understanding being in any way impaired by, for example, the size ratios of the insects and/or of parts of the insect traps 1 or of other of the illustrated elements not being drawn precisely or true to scale. On the basis of the more concretely explained realizations of the method according to the invention and on the basis of the more concretely explained functionality of the apparatus according to the invention in the figures, the reader as a person skilled in the art is thus enabled to derive a better understanding of the inventive idea, which is formulated in a more general and/or more abstract manner in the claims and in the general part of the description.

The invention has been described with reference to a preferred embodiment. Those skilled in the art will appreciate that numerous changes and modifications can be made to the preferred embodiments of the invention and that such changes and modifications can be made without departing from the spirit of the invention. It is therefore intended that the appended claims cover all such equivalent variations as fall within the true spirit and scope of the invention.

### LIST OF REFERENCE NUMBERS

1, 1a, 1b Insect trap
2 Hollow cylindrical collection container
3 Outflow surface
4 Airflow
5 Air blower
6 Intake duct
7 Dark contrast spot
8 Ambient air
9 Intake opening
10 Receiving device
11 Circular intake opening
12 Intake duct
13 Suction flow
14 Interior space
15 Frustoconical outer wall
16 Outflowing air
17 Net-like structure
18 Bottom side
19 Lower front side of intake duct
20 Fan
30 Insect
31 Mosquito
100, 100a, 100b Method
110 First method step
111 Second method step
112 Third method step
115 Intermediate method step
117 Fourth method step
120 Attractant composition
120* Attractant composition additionally loaded with scent
122 Packaging
S4 Flow velocity
S8 Flow velocity

We claim:

1. A method (100) used to produce an attractant composition (120) to attract bloodsucking arthropods (31) or fruit flies, comprising:
loading a porous substrate with a buffer system, wherein the buffer system is at least largely completely absorbed by the porous substrate, and
introducing at least one attractant into the substrate that is loaded with the buffer system.

2. The method (100) of claim 1, wherein the buffer system and the attractant are embedded in the pores of the substrate or are adsorbed to the outer surfaces of the substrate.

3. The method (100) of claim 1, wherein the attractant is slowly released to the surrounding area.

4. The method of claim 1, wherein the buffer system supports the absorption of the attractant into the substrate and the release of the attractant from the substrate.

5. The method of claim 1, wherein the buffer system comprises at least one aqueous ammonium salt of a carboxylic acid.

6. The method of claim 5, wherein the at least one attractant is selected from a group consisting of at least one C1 to C10 carboxylic acid and corresponding salts thereof.

7. The method of claim 1, wherein the attractant further comprises at least one scent.

8. The method (100) of claim 1, wherein the at least one attractant comprises at least one further attractant for bloodsucking arthropods (31) or fruit flies, wherein the at least one further attractant is selected from a group consisting of at least one C1 to C10 carboxylic acid and corresponding salts thereof.

9. The method (100) of claim 1, wherein the porous substrate is formed by an inert matrix having a pore size between 2 μm and 50 μm, in particular, a pore size between 5 μm and 30 μm, and which inert matrix is designed to absorb liquids.

10. An attractant composition (120) used to attract bloodsucking arthropods (31) or fruit flies, the attractant composition (120) comprising:
a. a porous substrate,
b. a buffer system; and
c. at least one attractant,
wherein the porous substrate is loaded with a buffer system that is largely completely absorbed by the porous substrate and the at least one attractant is introduced into the porous substrate loaded with the buffer system.

11. The attractant composition (120) of claim 10, wherein the buffer system is formed by aqueous ammonium salts of carboxylic acids.

12. The attractant composition (120) of claim 11, wherein the porous substrate is formed by an inert matrix, which inert matrix has a pore size between 5 μm and 100 μm.

13. The attractant composition (120) of claim 10, wherein attractant is selected from a group consisting of at least one C1 to C10 carboxylic acid and/or corresponding salts thereof.

14. (canceled)

15. The method of claim 3 wherein the attractant is slowly release to the surrounding area by evaporation.

16. The method of claim 4 wherein the buffer system supports the slow release of the attractant to the surrounding area.

17. The method of claim 5, wherein the buffer system comprises at least one aqueous ammonium salt of a fatty acid or at least one aqueous ammonium salt of acetic acid, lactic acid, propionic acid, butyric acid, valeric acid, caproic acid, enanthic acid, or caprylic acid.

18. The method of claim 6, wherein the at least one attractant is selected from a group consisting of formic acid, acetic acid, lactic acid, propionic acid, and caproic acid, or from a group comprising dichloromethane, trichloromethane, acetone, phenol, 1-Octen-3-ol, fermented yeast, an extract of fermented yeast, glycolic acid, thiolactic acid, thiolmalic acid, tartaric acid, mandelic acid and corresponding salts thereof.

19. The method of claim 8, wherein the at least one further attractant is selected from a group consisting of formic acid, acetic acid, lactic acid, propionic acid, and caproic acid, or from a group comprising dichloromethane, trichloromethane, acetone, phenol, 1-Octen-3-ol, fermented yeast, an extract of fermented yeast, glycolic acid, thiolactic acid, thiolmalic acid, tartaric acid, mandelic acid and corresponding salts thereof.

20. The method of claim 9, wherein the pore size between 5 μm and 30 μm.

21. The attractant composition (120) of claim 11, wherein the buffer system is formed by aqueous ammonium salts of fatty acids or aqueous ammonium salts of acetic acid, lactic acid, propionic acid, butyric acid, valeric acid, caproic acid, enanthic acid, or caprylic acid.
